(19) United States
(12) Patent Application Publication
(10) Pub. No.: US 2021/0263989 A1
(43) Pub. Date: Aug. 26, 2021

(54) MARK-UP COMPOSING APPARATUS AND METHOD FOR SUPPORTING MULTIPLE-SCREEN SERVICE

(71) Applicant: Samsung Electronics Co., Ltd., Suwon-si (KR)

(72) Inventor: Young-Sun RYU, Seongnam-si (KR)

(21) Appl. No.: 17/314,497

(22) Filed: May 7, 2021

Related U.S. Application Data
(63) Continuation of application No. 14/154,507, filed on Jan. 14, 2014.

(30) Foreign Application Priority Data
Jan. 14, 2013 (KR) 10-2013-0004173
Mar. 25, 2013 (KR) 10-2013-0031647

(51) Int. Cl. G06F 16/957; G06F 16/40; G06F 40/166; G06F 40/143

(52) U.S. Cl. CPC G06F 16/9577; G06F 40/143; G06F 40/166; G06F 16/40

(57) ABSTRACT

A method for providing a multimedia service in a server is provided. The method includes generating a mark-up file including at least scene layout information for supporting a multimedia service based on multiple screens, and providing the mark-up file to a multimedia device supporting the multimedia service based on multiple screens. The scene layout information may include scene layout information for one multimedia device and scene layout information for multiple multimedia devices.

### CROSS-REFERENCE TO RELATED APPLICATION(S)

This application is a continuation application of prior application Ser. No. 14/154,507, filed on Jan. 14, 2014, and is based on and claims priority under 35 U.S.C. § 119(a) of a Korean patent application number 10-2013-0004173, filed on Jan. 14, 2013 in the Korean Intellectual Property Office, and of a Korean patent application number 10-2013-0031647, filed on Mar. 25, 2013, in the Korean Intellectual Property Office, the disclosure of each of which is incorporated by reference herein its entirety.

### TECHNICAL FIELD

The present disclosure relates to a mark-up composing apparatus and method for supporting a multiple-screen service on a plurality of devices. More particularly, the present disclosure relates to an apparatus and a method for providing configuration information for a variety of digital devices with one mark-up file in an environment in which the variety of digital devices may share or deliver content over a network.

### BACKGROUND

A device supporting a multimedia service may process one mark-up (or a mark-up file) provided from a server and display the processing results for its user. The mark-up may be composed as a HyperText Markup Language (HTML) file, and the like.

FIG. 1 illustrates a structure of an HTML document composed of a mark-up according to the related art.

Referring to FIG. 1, an HTML is a mark-up language that defines the structure of one document with one file. HTML5, the latest version of HTML, has enhanced support for multimedia, such as video, audio, and the like. The HTML5 defines a tag capable of supporting a variety of document structures.

The HTML5 is not suitable for the service environment in which a plurality of devices are connected over a network, since the HTML5 is designed such that one device processes one document. Therefore, the HTML5 may not compose, as one and the same mark-up, the content that may be processed taking into account a connection relationship between a plurality of devices.

FIG. 2 illustrates a mark-up processing procedure in a plurality of devices connected over a network according to the related art.

Referring to FIG. 2, a web server 210 may provide web pages. If a plurality of devices are connected, the web server 210 may compose an HTML file and provide the HTML file to each of the plurality of connected devices individually.

For example, the web server 210 may separately prepare an HTML file (e.g., for provision of a Video on Demand (VoD) service) for a Digital Television (DTV) or a first device 220, and an HTML file (e.g., for a screen for a program guide or a remote control) for a mobile terminal or a second device 230.

The first device 220 and the second device 230 may request HTML files from the web server 210. The first device 220 and the second device 230 may render HTML files provided from the web server 210, and display the rendering results on their screens.

However, even though there is a dependent relationship in screen configuration, the first device 220 and the second device 230 may not display the dependent relationship. In order to receive a document associated with the first device 220, the second device 230 may keep its connection to the web server 210.

The first device 220 and the second device 230 need to secure a separate communication channel and interface, in order to handle events between the two devices.

The first device 220 and the second device 230 may not be aware of their dependencies on each other, even though the first device 220 and the second device 230 receive HTML files they need. The web server 210 may include a separate module for managing the dependencies between devices, in order to recognize the dependencies between the first device 220 and the second device 230.

Therefore, there is a need to prepare a way to support composition of a mark-up capable of supporting content taking into account a relationship between a plurality of devices based on HTML.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and a method for providing configuration information for a variety of digital devices with one mark-up file in an environment in which the variety of digital devices may share or deliver content over a network.

Another aspect of the present disclosure is to provide an apparatus and a method, in which a plurality of digital devices connected over a network display media (e.g., audio and video), image, and text information that they will process, based on a mark-up composed to support a multi-screen service.

Another aspect of the present disclosure is to provide an apparatus and a method, in which a service provider provides information that a device will process as a primary device or a secondary device, using one mark-up file depending on the role assigned to each of a plurality of digital devices connected over a network.

Another aspect of the present disclosure is to provide an apparatus and a method, in which a service provider provides, using a mark-up file, information that may be processed in each device depending on a connection relationship between devices, in the situation where a plurality of devices are connected.

In accordance with an aspect of the present disclosure, a method for providing a multimedia service in a server is provided. The method includes generating a mark-up file including at least scene layout information for supporting a multimedia service based on multiple screens, and providing the mark-up file to a multimedia device supporting the multimedia service based on multiple screens. The scene layout information may include scene layout information for one multimedia device and scene layout information for multiple multimedia devices.

In accordance with another aspect of the present disclosure, a server for providing a multimedia service is provided. The server includes a mark-up generator configured to generate a mark-up file including at least scene layout information for supporting a multimedia service based on multiple screens, and a transmitter configured to provide the mark-up file generated by the mark-up generator to a multimedia device supporting the multimedia service based on multiple screens. The scene layout information may include scene layout information for one multimedia device and scene layout information for multiple multimedia devices.

In accordance with another aspect of the present disclosure, a method for providing a multimedia service in a multimedia device is provided. The method includes receiving a mark-up file from a server supporting the multimedia service, if the multimedia device is a main multimedia device for the multimedia service, determining whether there is any sub multimedia device that is connected to a network, for the multimedia service, if the sub multimedia device does not exist, providing a first screen for the multimedia service based on scene layout information for one multimedia device, which is included in the received mark-up file, and if the sub multimedia device exists, providing a second screen for the multimedia service based on scene layout information for multiple multimedia devices, which is included in the received mark-up file.

In accordance with another aspect of the present disclosure, a multimedia device for providing a multimedia service is provided. The multimedia device includes a connectivity module configured, if the multimedia device is a main multimedia device for the multimedia service, to determine whether there is any sub multimedia device that is connected to a network, for the multimedia service, and an event handler configured to provide a screen for the multimedia service based on a determination result of the connectivity module and a mark-up file received from a server supporting the multimedia service. If it is determined by the connectivity module that the sub multimedia device does not exist, the event handler may provide a first screen for the multimedia service based on scene layout information for one multimedia device, which is included in the received mark-up file, and if it is determined by the connectivity module that the sub multimedia device exists, the event handler may provide a second screen for the multimedia service based on scene layout information for multiple multimedia devices, which is included in the received mark-up file.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a structure of a HyperText Markup Language (HTML) document composed of a mark-up according to the related art;

FIG. 2 illustrates a mark-up processing procedure in a plurality of devices connected over a network according to the related art;

FIG. 3 illustrates a mark-up processing procedure in a plurality of devices connected over a network according to an embodiment of the present disclosure;

FIG. 4 illustrates a browser for processing a mark-up according to an embodiment of the present disclosure;

FIG. 5A illustrates a structure of a mark-up for controlling a temporal and a spatial layout and synchronization of multimedia according to an embodiment of the present disclosure;

FIG. 5B illustrates layout information of a scene in a structure of a mark-up for controlling a temporal and a spatial layout and synchronization of multimedia configured as a separate file according to an embodiment of the present disclosure;

FIG. 6 illustrates a control flow performed by a primary device in an environment where a plurality of devices are connected over a network according to an embodiment of the present disclosure;

FIG. 7 illustrates a control flow performed by a secondary device in an environment where a plurality of devices are connected over a network according to an embodiment of the present disclosure;

FIGS. 8 and 9 illustrate a connection relationship between modules constituting a primary device and a secondary device according to an embodiment of the present disclosure;

FIGS. 10, 11, and 12 illustrate a mark-up composing procedure according to embodiments of the present disclosure;

FIG. 13 illustrates an area information receiving procedure according to an embodiment of the present disclosure; and

FIG. 14 illustrates a structure of a server providing a multimedia service based on multiple screens according to an embodiment of the present disclosure.

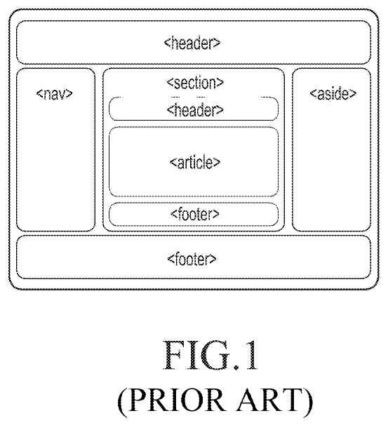

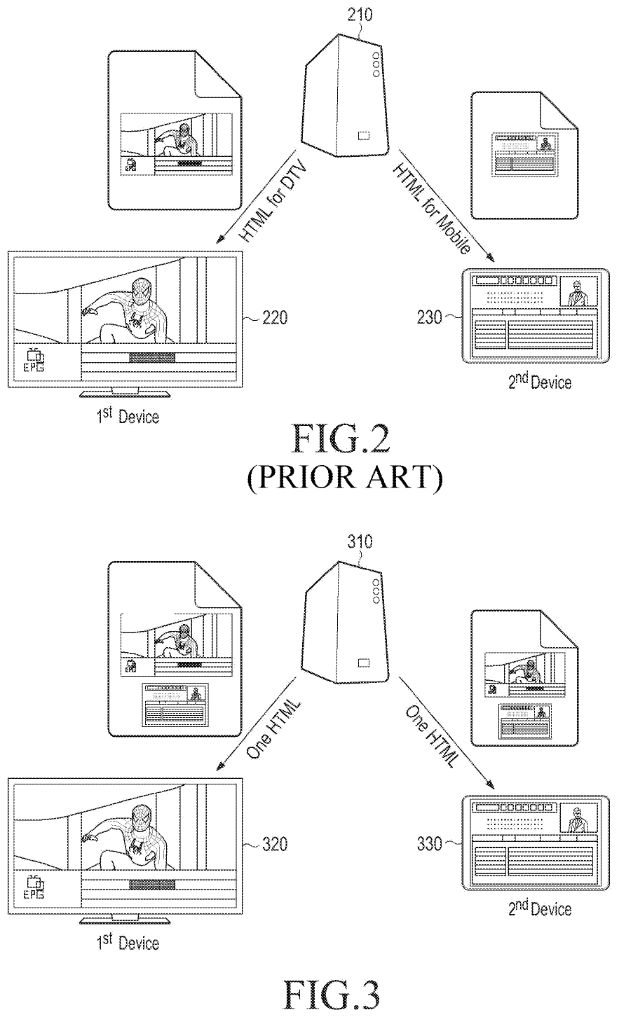

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Reference will now be made to the accompanying drawings to describe an embodiment of the present disclosure.

FIG. 3 illustrates a mark-up processing procedure in a plurality of devices connected over a network according to an embodiment of the present disclosure.

Referring to FIG. 3, a web server 310 may compose one HyperText Markup Language (HTML) file including information for both of a first device 320 and a second device 330. The web server 310 may provide the composed one HTML file to each of the first device 320 and the second device 330.

The first device 320 and the second device 330 may parse and display their needed part from the HTML file provided from the web server 310.

Referring to FIG. 3, the first device 320 and the second device 330 may directly receive an HTML file from the web server 310. On the other hand, the HTML file provided by the web server 310 may be sequentially delivered to a plurality of devices. For example, the web server 310 may provide an HTML file to the first device 320. The first device 320 may process the part that the first device 320 will process, in the provided HTML file. The first device 320 may deliver the part for the second device 330 in the provided HTML file, to the second device 330 so that the second device 330 may process the delivered part.

Alternatively, even in the situation where the second device 330 may not directly receive an HTML file from the web server 310, the second device 330 may receive a needed HTML file and display a desired screen, if the second device 330 keeps its connection to the first device 320.

For example, the information indicating the part that each device will process may be provided using a separate file. In this case, a browser may simultaneously process an HTML file that provides screen configuration information, and a separate file that describes the processing method for a plurality of devices. A description thereof will be made herein below.

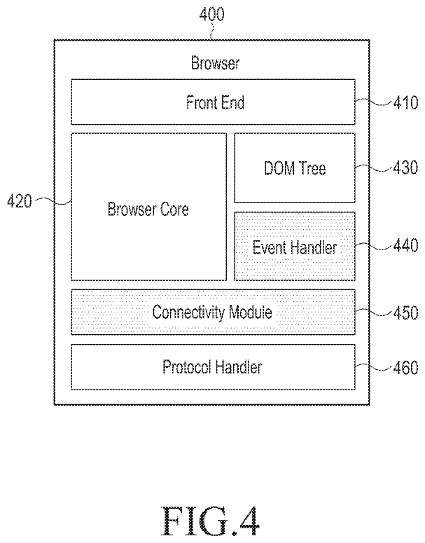

FIG. 4 illustrates a browser for processing a mark-up according to an embodiment of the present disclosure.

Referring to FIG. 4, a browser 400 may include a front end 410, a browser core 420, a Document Object Model (DOM) tree 430, an event handler 440, a connectivity module 450, and a protocol handler 460.

The role of each module constituting the browser 400 is as follows.

1) The front end 410: is a module that reads the DOM tree 430 and renders the DOM tree 430 on a screen for the user.

2) The browser core 420: is the browser's core module that parses a mark-up file, interprets and processes tags, and composes the DOM tree 430 using the processing results. The browser core 420 may not only perform the same function as that of a processing module of the common browser, but also additionally performs the function of processing newly defined elements and attributes.

3) The DOM tree 430: refers to a data structure that the browser core 420 has interpreted mark-ups and made elements in the form of one tree. The DOM tree 430 is the same as a DOM tree of the common browser.

4) The event handler 440: Generally, an event handler of a browser is a module that handles an event entered by the user, or an event (e.g., time out processing, and the like) occurring within a device. In the proposed embodiment, if changes occur (e.g., if a second device (or a first device) is added or excluded), the event handler 440 may receive this event from the connectivity module 450 and deliver it to the DOM tree 430, to newly change the screen configuration.

5) The connectivity module 450: plays a role of detecting a change (e.g., addition/exclusion of a device in the network), generating the change in circumstances as an event, and delivering the event to the event handler 440.

6) The protocol handler 460: plays a role of accessing the web server and transmitting a mark-up file. The protocol handler 460 is the same as a protocol handler of the common browser.

Among the components of the browser 400, the modules which are added or changed for the proposed embodiment may include the event handler 440 and the connectivity module 450. The other remaining modules may be generally the same as those of the common browser in terms of the operation. Therefore, in the proposed embodiment, a process of handling the elements and attributes corresponding to the event handler 440 and the connectivity module 450 is added.

Thereafter, a description will be made of a mark-up defined for the proposed embodiment.

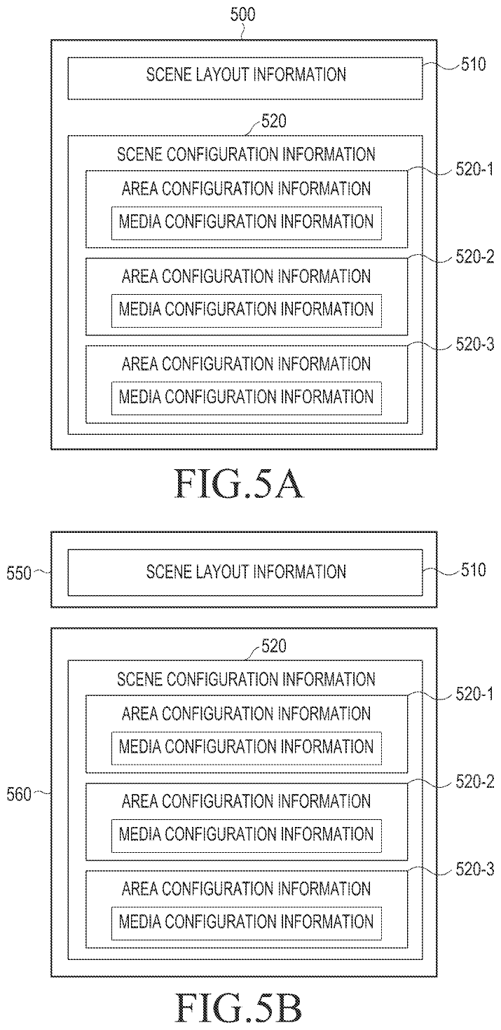

FIG. 5A illustrates a structure of a mark-up for controlling a temporal and a spatial layout and synchronization of multimedia according to an embodiment of the present disclosure.

Referring to FIG. 5A, a mark-up file 500 may include scene layout information 510 and scene configuration information 520. The scene configuration information 520 may include a plurality of area configuration information 520-1, 520-2, and 520-3. Each of the plurality of area configuration information 520-1, 520-2, and 520-3 may include at least one piece of media configuration information. The term ‘media’ as used herein may not be limited to a particular type (e.g., video and audio) of information. The media may be extended to include images, texts, and the like. Therefore, the media in the following description should be construed to include not only the video and audio, but also various types of media, such as images, texts, and the like.

Table 1 below illustrates an example of the mark-up file illustrated in FIG. 5A and composed as an HTML file.

TABLE 1

<html>
<head>
<view> // Scene Layout Information
<divLocation/>
<divLocation/>
<divLocation/>
</view>
</head>
<body> // Scene Configuration Information
<div> // Area1 Configuration Information
<video/> // Media1 Configuration Information
</div>
<div> // Area2 Configuration Information
<text/> // Media2 Configuration Information
</div>
<div> // Area3 Configuration Information
<text/> // Media3 Configuration Information
</div>
</body>
</html>

As illustrated in Table 1, in a <head> field may be recorded layout information corresponding to the entire screen scene composed of a <view> element and its sub elements of <divLocation>. In a <body> field may be recorded information constituting the actual scene, by being divided into area configuration information, which is a sub structure. The area configuration information denotes one area that can operate independently. The area may contain actual media information (e.g., video, audio, images, texts, and the like).

The scene layout information constituting the mark-up illustrated in FIG. 5A may be configured and provided as a separate file.

FIG. 5B illustrates layout information of a scene in a structure of a mark-up for controlling a temporal and a spatial layout and synchronization of multimedia configured as a separate file according to an embodiment of the present disclosure.

Referring to FIG. 5B, a mark-up file may include a mark-up 550 describing scene layout information 510, and a mark-up 560 describing scene configuration information 520. The two mark-ups 550 and 560 composed of different information may be configured to be distinguished in mark-up files.

Tables 2A and 2B below illustrate examples of the mark-up files illustrated in FIG. 5B and composed as HTML files.

TABLE 2A

<xml>
<ci>
<view> // Scene Layout Information
<divLocation/>
<divLocation/>
<divLocation/>
</view>
</ci>
</xml>

TABLE 2B
<html>
<head> </head>
<body> // Scene Configuration Information
<div id=“Area1”> // Area1 Configuration Information
<video/> // Media1 Configuration Information
</div>
<div id=“Area2”> // Area2 Configuration Information
<text/> // Media2 Configuration Information
</div>
<div id=“Area3”> // Area3 Configuration Information
<text/> // Media3 Configuration Information
</div>
</body>
</html>

As illustrated in Tables 2A and 2B, a <view> element and its sub elements of <divLocation>, used to record layout information corresponding to the entire screen scene, may be configured as a separate file. If the scene layout information is separately configured and provided, each device may simultaneously receive and process the mark-up 550 describing the scene layout information 510 and the mark-up 560 describing the scene configuration information 520. Even in this case, though two mark-ups are configured separately depending on their description information, each device may receive and process the same mark-up.

In the proposed embodiment, attributes are added to the scene layout information in order to display a connection relationship between devices and the information that a plurality of devices should process depending on the connection relationship, in the plurality of devices using the scene configuration information.

A description will now be made of the attributes, which are added to the scene layout information to display the information that may be processed.

1. viewtype: it represents a type of the scene corresponding to the scene layout information. Specifically, viewtype is information used to indicate whether the scene layout information is for supporting a multimedia service by one primary device, or for supporting a multimedia service by one primary device and at least one secondary device.

Table 3 below illustrates an example of the defined meanings of the viewtype values.

TABLE 3

| viewtype | description |
|---|---|
| default | Default value. It indicates that one device is connected to |
| | the network. |
| multiple | It indicates that a plurality of devices are connected to the |
| | network. |
| receptible | It defines an empty space to make it possible to receive area |
| | information from the external device. |

In Table 3, ‘one device is connected to the network’ denotes that the multimedia service is provided by the primary device, and ‘a plurality of devices are connected to the network’ denotes that the multimedia service is provided by one primary device and at least one secondary device.

2. divLocation: it is location information used to place at least one scene on a screen for a multimedia service by one primary device, or by one primary device and at least one secondary device. For example, if a multimedia service is provided by one primary device, the divLocation may be defined for each of at least one scene constituting a screen of the primary device. On the other hand, if a multimedia service is provided by one primary device and at least one secondary device, the divLocation may be defined not only for each of at least one scene constituting a screen of the primary device, but also for each of at least one scene constituting a screen of the at least one secondary device.

3. plungeOut: it indicates how an area may be shared/distributed by a plurality of devices. In other words, it defines a type of the scene that is to be displayed on a screen by a secondary device. For example, plungeOut may indicate whether the scene is a scene that is shared with the primary scene, whether the scene is a scene that has moved to a screen of the secondary device after excluded from the screen of the primary device, and is displayed on the screen of the secondary device, or whether the scene is a newly provided scene.

Table 4 below illustrates an example of the defined meanings of the plungeOut values.

TABLE 4

| plungeOut | description |
|---|---|
| sharable | Area can be shared in secondary device |
| dynamic | Area moves to secondary device |
| complementary | Area is additionally provided in secondary device |

In the proposed embodiment, if a plurality of devices are connected over the network, a plurality of scene layout information may be configured to handle them. The newly defined viewtype and plungOut may operate when a plurality of scene layout information is configured.

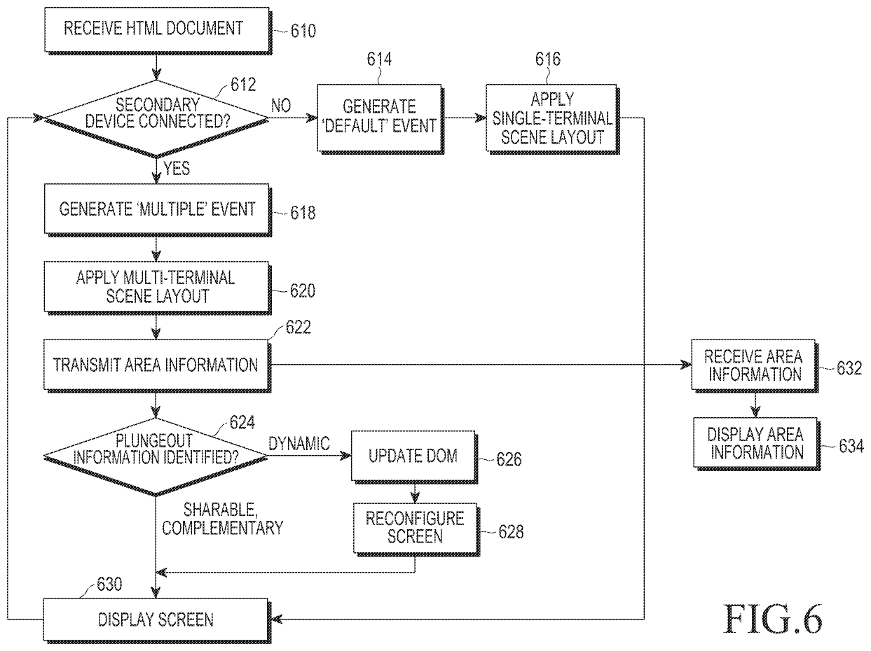

FIG. 6 illustrates a control flow performed by a primary device in an environment where a plurality of devices are connected over a network according to an embodiment of the present disclosure. The term ‘primary device’ may refer to a device that directly receives, at a receiver therein, a mark-up document from a web server, and processes, in at least one processor therein, the received mark-up. For example, the primary device may be a device supporting a large screen, such as a Digital Television (DTV), and the like.

Referring to FIG. 6, the primary device may directly receive a service. In operation 610, the primary device may receive a mark-up document written in HTML from a web server. Upon receiving the mark-up document, the primary device may determine in operation 612 whether a secondary device is connected to the network, through the connectivity module.

If it is determined in operation 612 that no secondary device is connected, the primary device may generate a ‘default’ event through the connectivity module in operation 614. In operation 616, the primary device may read scene layout information (in which a viewtype attribute of a view element is set as ‘default’) corresponding to ‘default’ in the scene layout information of the received mark-up document, and interpret the read information to configure and display a screen.

The primary device may continue to check the connectivity module, and if it is determined in operation 612 that a secondary device is connected, the primary device may generate a ‘multiple’ event in operation 618. In operation 620, the primary device may read layout information (in which a viewtype attribute of a view element is set as ‘multiple’) corresponding to ‘multiple’ in the scene layout information of the mark-up document, and apply the read information.

In operation 622, the primary device may read a divLocation element, which is sub element information of the view element, and transmit, to the secondary device, area information in which a ‘plungeOut’ attribute thereof is set. The ‘plungeOut’ attribute may have at least one of the three values defined in Table 4.

In operation 624, the primary device determines a value of the ‘plungeOut’ attribute. If it is determined in operation 624 that the ‘plungeOut’ attribute has a value of ‘sharable’ and ‘complementary’, the primary device does not need to change DOM since its scene configuration information is not changed. Therefore, in operation 630, the primary device may display a screen based on the scene configuration information. In this case, the contents displayed on the screen may not be changed.

On the other hand, if it is determined in operation 624 that the ‘plungeOut’ attribute has a value of ‘dynamic’, the primary device may change DOM since its scene configuration information is changed. Therefore, in operation 626, the primary device may update DOM. The primary device may reconfigure the screen based on the updated DOM in operation 628, and display the reconfigured screen in operation 630.

Even when the secondary device exits from the network, a changed event may be generated by the connectivity module provided in the primary device, and its handling process has been described above.

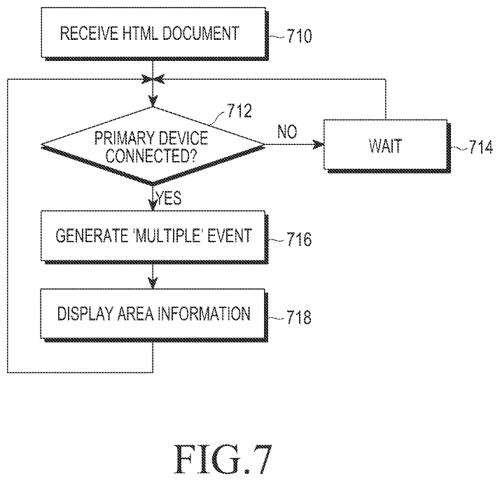

FIG. 7 illustrates a control flow performed by a secondary device in an environment where a plurality of devices are connected over a network according to an embodiment of the present disclosure. The term ‘secondary device’ refers to a device that operates in association with the primary device. Generally, the secondary device is a device with a small screen, such as mobile devices, tablet devices, and the like, and may display auxiliary information about a service enjoyed in the primary device, or may be responsible for control of the primary device.

The secondary device may perform two different operations depending on its service receiving method. The operations may be divided into an operation performed when the secondary device directly receives a service from the web server, and an operation performed when the secondary device cannot directly receive a service from the web server.

Referring FIG. 7, when the secondary device directly receives a service from the web server, the secondary device may receive a mark-up document written in HTML from the web server in operation 710. After receiving the mark-up document, the secondary device may determine in operation 712 whether the primary device (or the first device) is connected to the network, through the connectivity module.

If it is determined in operation 712 that the primary device is not connected to the network, the secondary device may wait in operation 714 until the primary device is connected to the network, because the second device cannot handle the service by itself.

On the other hand, if it is determined in operation 712 that the primary device has been connected to the network or is newly connected to the network at the time the secondary device receives the mark-up document, the secondary device may generate a ‘multiple’ event through the connectivity module in operation 716. In operation 718, the secondary device may read information corresponding to ‘multiple’ from the scene layout information, interpret information about the area where a plungeOut value of divLocation in the read information is set, and display the interpreted information on its screen.

Thereafter, when the secondary device cannot directly receive a service from the web server, the secondary device may receive the area information corresponding to the secondary device itself, from the primary device, interpret the received information, and display the interpretation results on the screen. This operation of the secondary device is illustrated in operations 632 and 634 in FIG. 6.

Referring back to FIG. 6, it additionally illustrates operations 632 and 634, which are performed by the secondary device. In operation 632, the secondary device may receive the area information transmitted from the primary device. In operation 634, the secondary device may display a screen based on the received area information.

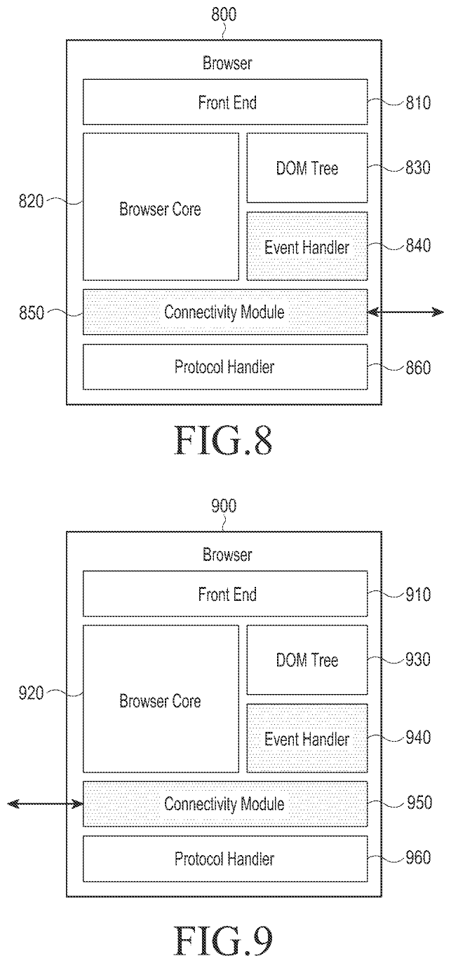

FIGS. 8 and 9 illustrate a connection relationship between modules constituting a primary device and a secondary device according to an embodiment of the present disclosure. More specifically, FIG. 8 illustrates a module structure constituting a primary device according to an embodiment of the present disclosure, and FIG. 9 illustrates a module structure constituting a secondary device according to an embodiment of the present disclosure.

Referring to FIG. 8, a browser 800 may include a front end 810, a browser core 820, a DOM tree 830, an event handler 840, a connectivity module 850, and a protocol handler 860. Referring to FIG. 9, a browser 900 may include a front end 910, a browser core 920, a DOM tree 930, an event handler 940, a connectivity module 950, and a protocol handler 960. It can be noted in FIGS. 8 and 9 that the primary device and the secondary device are connected to each other by the connectivity module 850 among the modules constituting the primary device and the connectivity module 950 among the modules constituting the secondary device. In other words, the primary device and the secondary device are connected over the network by their connectivity modules. More particularly, the connectivity module 850 of the primary device and the connectivity module 950 of the secondary device may perform information exchange between the primary device and the secondary device, and generate events in their devices.

It can be noted that the module structures of the primary device and secondary device, which are illustrated in FIGS. 8 and 9, are the same as the module structure described in conjunction with FIG. 4.

Now, how the primary device may process the scene layout information will be described with reference to the actual mark-up.

Table 5 below illustrates an example in which one mark-up includes two view elements.

TABLE 5
<head>
<view id=“view1” viewtype=“default”>
<divLocation id=“div1” refDiv=“Area1”/>
</view>
<view id=“view2” viewtype=“multiple”>
<divLocation id=“div1” refDiv=“Area1”/>
<divLocation id=“div2” refDiv=“Area2” plungeOut =“complementary”/>
</view>
</head>

In Table 5, each view element may be distinguished by a viewtype attribute. A view, in which a value of the viewtype attribute is set as ‘default’, is scene layout information for the case where one device exists in the network. A view, in which a value of the viewtype attribute is set as ‘multiple’, is scene layout information for the case where a plurality of devices exists in the network.

If one device exists in the network, the scene layout information in the upper block may be applied in Table 5. The scene layout information existing in the upper block and corresponding to the mark-up has one-area information. Therefore, one area may be displayed on the screen of the primary device.

However, if at least one secondary device is added to the network, the connectivity module may generate a ‘multiple’ event. Due to the generation of the ‘multiple’ event, the scene layout information in the lower block may be applied in Table 5. The scene layout information existing in the lower block and corresponding to the mark-up has two-area information. In the two-area information, a plungOut attribute of divLocation distinguished by id=‘divL2’ is designated as ‘complementary’, so this area information may not be actually displayed on the primary device. In other words, Area1 information may be still displayed on the primary device, and the secondary device may receive and display Area2 information.

When scene layout information is configured as a separate mark-up in FIG. 5B, the view elements in Table 5 may be described in a separate mark-up. Each device processing the view elements may receive the mark-up describing scene configuration information and simultaneously process the received mark-up. The same information is separated and described in the separate mark-up, merely for convenience of service provision. Therefore, there is no difference in the handling process by the device, so the handling process will not be described separately.

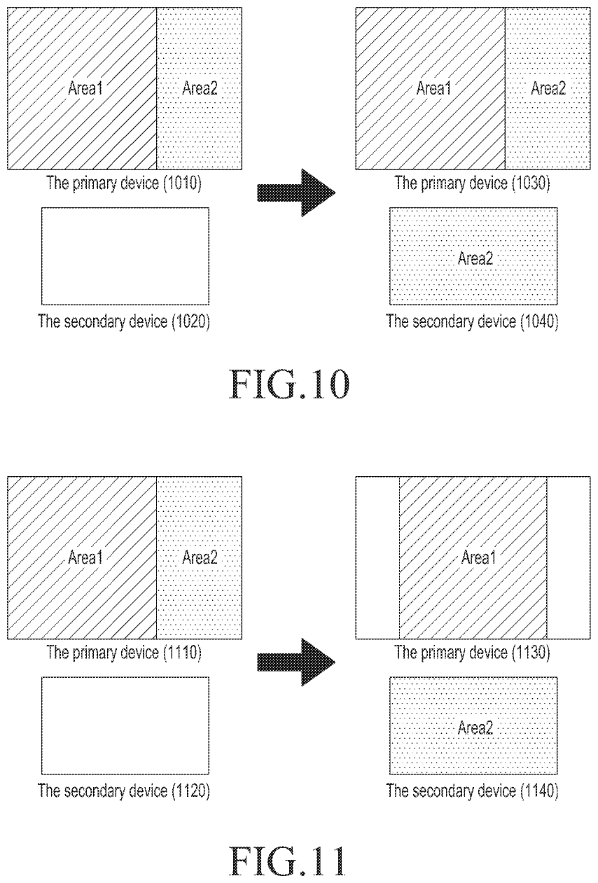

Examples of composing a mark-up according to the proposed embodiment are illustrated in FIGS. 10, 11, and 12.

FIG. 10 illustrates a mark-up composing procedure according to an embodiment of the present disclosure.

Referring to FIG. 10, a certain area may be shared by the primary device and the secondary device. On the left side of FIG. 10, a primary device 1010, which is connected to the network, may display areas Area1 and Area2. For example, on the left side of FIG. 10, a secondary device 1020 is not connected to the network.

If a secondary device 1040 is connected to the network, a primary device 1030 may still display the areas Area1 and Area2, and Area2 among Area1 and Area2 displayed on the primary device 1030 may be displayed on the newly connected secondary device 1040, as illustrated on the right side of FIG. 10.

The embodiment described in conjunction with FIG. 10 may be represented in code as in Table 6 below.

```
TABLE 6
<!DOCTYPE html>
<html xmlns=“http://www.w3.org/1999/xhtml”>
<head>
  <MMT-CI:LoA>
    <MMT-CI:AI id=“Asset1” src=“mmt://package1/asset1” MMT-
CI:mediatype=“video”/>
    <MMT-CI:AI id=“Asset2” src=“mmt://package1/asset2” MMT-
CI:mediatype=“video”/>
  </MMT-CI:LoA>
  <MMT-CI:view id=“View1” MMT-CI:viewtype=“default” MMT-
CI:width=“1920px” MMT-CI:height=“1080px”>
    <MMT-CI:divLocation id=“divL1” MMT-CI:width=“70%” MMT-
CI:height=“100%” MMT-CI:left=“0%” MMT-CI:top=“0%” MMT-
CI:refDiv=“Area1”/>
    <MMT-CI:divLocation id=“divL2” MMT-CI:width=“30%” MMT-
CI:height=“100%” MMT-CI:left=“70%” MMT-CI:top=“0%” MMT-
CI:refDiv=“Area2”>
  </MMT-CI:view>
  <MMT-CI:view id=“View2” MMT-CI:viewtype=“multiple” MMT-
CI:width=“1920px” MMT-CI:height=“1080px”>
    <MMT-CI:divLocation id=“divL1” MMT-CI:width=“70%” MMT-
CI:height=“100%” MMT-CI:left=“0%” MMT-CI:top=“0%” MMT-
CI:refDiv=“Area1”/>
    <MMT-CI:divLocation id=“divL2” MMT-CI:width=“30%” MMT-
CI:height=“100%” MMT-CI:left=“70%” MMT-CI:top=“0%” MMT-
CI:refDiv=“Area2” MMT-CI:plungeOut=“sharable”/>
  </MMT-CI:view>
</head>
<body>
  <div id=“Area1” MMT-CI:width=“1000px” MMT-CI:height=“1000px”>
    <video id=“video1” MMT-CI:refAsset=“Asset1” MMT-
CI:width=“100%” MMT-CI:height=“100%” MMT-CI:left=“0px” MMT-
CI:top=“0px”/>
  </div>
  <div id=“Area2” MMT-CI:width=“600px” MMT-CI:height=“1000px”>
    <video id=“video2” MMT-CI:refAsset=“Asset2” MMT-
CI:width=“100%” MMT-CI:height=“100%” MMT-CI:left=“0px” MMT-
CI:top=“0px”/>
  </div>
</body>
</html>
```

On the other hand, when the scene layout information is configured as a separate mark-up, the embodiment described in conjunction with FIG. 10 may be represented in code as in Table 7 below.

```
TABLE 7
<?xml version=“1.0” encoding=“UTF-8”?>
<MMT-CI>
<MMT-CI:LoA>
    <MMT-CI:AI id=“Asset1” src=“mmt://package1/asset1” MMT-
CI:mediatype=“video”/>
    <MMT-CI:AI id=“Asset2” src=“mmt://package1/asset2” MMT-
CI:mediatype=“video”/>
</MMT-CI:LoA>
<MMT-CI:view id=“View1” MMT-CI:viewtype=“default” MMT-
CI:width=“1920px” MMT-CI:height=“1080px”>
    <MMT-CI:divLocation id=“divL1” MMT-CI:width=“70%” MMT-
CI:height=“100%” MMT-CI:left=“0%” MMT-CI:top=“0%” MMT-
CI:refDiv=“Area1”/>
    <MMT-CI:divLocation id=“divL2” MMT-CI:width=“30%” MMT-
CI:height=“100%” MMT-CI:left=“70%” MMT-CI:top=“0%” MMT-
CI:refDiv=“Area2”>
</MMT-CI:view>
<MMT-CI:view id=“View2” MMT-CI:viewtype=“multiple” MMT-
CI: width=“1920px” MMT-CI:height=“1080px”>
    <MMT-CI:divLocation id=“divL1” MMT-CI:width=“70%” MMT-
CI:height=“100%” MMT-CI:left=“0%” MMT-CI:top=“0%” MMT-
CI:refDiv=“Area1”/>
    <MMT-CI:divLocation id=“divL2” MMT-CI:width=“30%” MMT-
CI:height=“100%” MMT-CI:left=“70%” MMT-CI:top=“0%” MMT-
CI:refDiv=“Area2” MMT-CI:plungeOut=“sharable”/>
</MMT-CI:view>
</MMT-CI>
<!DOCTYPE html>
<html xmlns=“http://www.w3.org/1999/xhtml”>
<body>
  <div id=“Area1” MMT-CI:width=“1000px” MMT-CI:height=“1000px”>
    <video id=“video1” MMT-CI:refAsset=“Asset1” MMT-
CI:width=“100%” MMT-CI:height=“100%” MMT-CI:left=“0px” MMT-
CI:top=“0px”/>
  </div>
  <div id=“Area2” MMT-CI:width=“600px” MMT-CI:height=“1000px”>
    <video id=“video2” MMT-CI:refAsset=“Asset2” MMT-
CI:width=“100%” MMT-CI:height=“100%” MMT-CI:left=“0px” MMT-
CI:top=“0px”/>
  </div>
</body>
</html>
```

As illustrated in Table 7, the scene layout information is merely described in a separate file, and there is no difference in contents of the mark-up. In Table 7, the first box and the second box may correspond to different files. For example, the first box may correspond to a file with a file name of “Sceane.xml”, and the second box may correspond to a file with a file name of “Main.html”.

FIG. 11 illustrates a mark-up composing procedure according to an embodiment of the present disclosure.

Referring to FIG. 11, if a secondary device is connected, specific area information which was being displayed on the primary device may move to the secondary device. On the left side of FIG. 11, a primary device 1110, which is connected to the network, may display areas Area1 and Area2. For example, on the left side of FIG. 11, a secondary device 1120 is not connected to the network.

If a secondary device 1140 is connected to the network, a primary device 1130 may display the area Area1, and the area Area2 which was being displayed on the primary device 1130 may be displayed on the newly connected secondary device 1140, as illustrated on the right side of FIG. 11.

The embodiment described in conjunction with FIG. 11 may be represented in code as in Table 8 below.

```
TABLE 8
<!DOCTYPE html>
<html xmlns=“http://www.w3.org/1999/xhtml”>
<head>
  <MMT-CI:LoA>
    <MMT-CI:AI id=“Asset1” src=“mmt://package1/asset1” MMT-
CI:mediatype=“video”/>
    <MMT-CI:AI id=“Asset2” src=“mmt://package1/asset2” MMT-
CI:mediatype=“video”/>
  </MMT-CI:LoA>
  <MMT-CI:view id=“View1” MMT-CI:viewtype=“default” MMT-
CI:width=“1920px” MMT-CI:height=“1080px”>
    <MMT-CI:divLocation id=“divL1” MMT-CI:width=“70%” MMT-
CI:height=“100%” MMT-CI:left=“0%” MMT-CI:top=“0%” MMT-
CI:refDiv=“Area1”/>
    <MMT-CI:divLocation id=“divL2” MMT-CI:width=“30%” MMT-
CI:height=“100%” MMT-CI:left=“70%” MMT-CI:top=“0%” MMT-
CI:refDiv=“Area2”>
  </MMT-CI:view>
  <MMT-CI:view id=“View2” MMT-CI:viewtype=“multiple” MMT-
CI:width=“1920px” MMT-CI:height=“1080px”>
    <MMT-CI:divLocation id=“divL1” MMT-CI:width=“70%” MMT-
CI:height=“100%” MMT-CI:left=“0%” MMT-CI:top=“0%” MMT-
CI:refDiv=“Area1”/>
    <MMT-CI:divLocation id=“divL2” MMT-CI:width=“30%” MMT-
CI:height=“100%” MMT-CI:left=“70%” MMT-CI:top=“0%” MMT-
CI:refDiv=“Area2” MMT-CI:plungeOut=“sharable”/>
  </MMT-CI:view>
</head>
<body>
  <div id=“Area1” MMT-CI:width=“1000px” MMT-CI:height=“1000px”>
    <video id=“video1” MMT-CI:refAsset=“Asset1” MMT-CI:width=
“100%” MMT-CI:height=“100%” MMT-CI:left=“0px”
MMT-CI:top=“0px”/>
  </div>
  <div id=“Area2” MMT-CI:width=“600px” MMT-CI:height=“1000px”>
    <video id=“video2” MMT-CI:refAsset=“Asset2” MMT-CI:width=
“100%” MMT-CI:height=“100%” MMT-CI:left=“0px”
MMT-CI:top=“0px”/>
  </div>
</body>
</html>
```

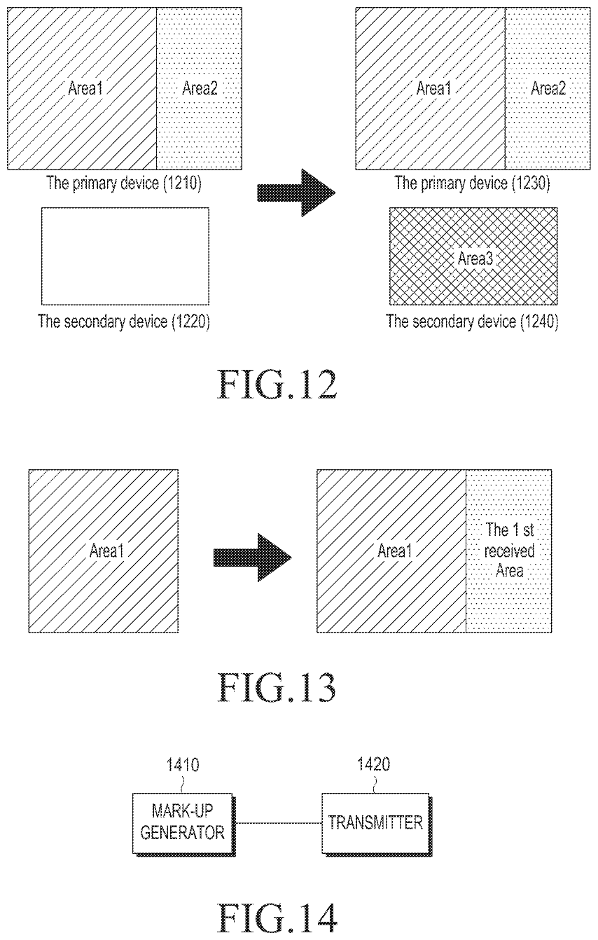

FIG. 12 illustrates a mark-up composing procedure according to an embodiment of the present disclosure.

Referring to FIG. 12, a new area may be displayed on a newly connected secondary device regardless of the areas displayed on a primary device. On the left side of FIG. 12, a primary device 1210, which is connected to the network, may display areas Area1 and Area2. For example, on the left side of FIG. 12, a secondary device 1220 is not connected to the network.

If a secondary device 1240 is connected to the network, a primary device 1230 may still display the areas Area1 and Area2, as illustrated on the right side of FIG. 12. The newly connected secondary device 1240 may display new complementary information (e.g., Area3 information) which is unrelated to the areas Area1 and Area2 which are being displayed on the primary device 1230.

The embodiment described in conjunction with FIG. 12 may be represented in code as in Table 9 below.

```
TABLE 9
<!DOCTYPE html>
<html xmlns=“http://www.w3.org/1999/xhtml”>
<head>
  <MMT-CI:LoA>
    <MMT-CI:AI id=“Asset1” src=“mmt://package1/asset1” MMT-
CI:mediatype=“video”/>
    <MMT-CI:AI id=“Asset2” src=“mmt://package1/asset2” MMT-
CI:mediatype=“video”/>
    <MMT-CI:AI id=“Asset3” src=“mmt://package1/asset3” MMT-
CI:mediatype=“widget”/>
  </MMT-CI:LoA>
  <MMT-CI:view id=“View1” MMT-CI:viewtype=“default” MMT-
CI:width=“1920px” MMT-CI:height=“1080px”>
    <MMT-CI:divLocation id=“divL1” MMT-CI:width=“70%” MMT-
CI:height=“100%” MMT-CI:left=“0%” MMT-CI:top=“0%” MMT-
CI:refDiv=“Area1”/>
    <MMT-CI:divLocation id=“divL2” MMT-CI:width=“30%” MMT-
CI:height=“100%” MMT-CI:left=“70%” MMT-CI:top=“0%” MMT-
CI:refDiv=“Area2”/>
  </MMT-CI:view>
  <MMT-CI:view id=“View2” MMT-CI:viewtype=“multiple” MMT-
CI:width=“1920px” MMT-CI:height=“1080px”>
    <MMT-CI:divLocation id=“divL1” MMT-CI:width=“70%” MMT-
CI:height=“100%” MMT-CI:left=“0%” MMT-CI:top=“0%” MMT-
CI:refDiv=“Area1”/>
    <MMT-CI:divLocation id=“divL2” MMT-CI:width=“30%” MMT-
CI:height=“100%” MMT-CI:left=“70%” MMT-CI:top=“0%” MMT-
CI:refDiv=“Area2”/>
    <MMT-CI:divLocation id=“divL3” MMT-CI:width=“1024px” MMT-
CI:height=“768px” MMT-CI:left=“0px” MMT-CI:top=“0px” MMT-
CI:refDiv=“Area3” MMT-CI:plungeOut=“complementary”/>
  </MMT-CI:view>
</head>
<body>
  <div id=“Area1” MMT-CI:width=“1000px” MMT-CI:height=“1000px”>
    <video id=“video1” MMT-CI:refAsset=“Asset1” MMT-
CI:width=“100%” MMT-CI:height=“100%” MMT-CI:left=“0px” MMT-
CI:top=“0px”/>
  </div>
  <div id=“Area2” MMT-CI:width=“600px” MMT-CI:height=“1000px”>
    <video id=“video2” MMT-CI:refAsset=“Asset2” MMT-
CI:width=“100%” MMT-CI:height=“100%” MMT-CI:left=“0px” MMT-
CI:top=“0px”/>
  </div>
  <div id=“Area3” MMT-CI:width=“1024px” MMT-CI:height=“768px”>
    <MMT-CI:widget id=“widget1” MMT-CI:refAsset=“Asset3” MMT-
CI:width=“100%” MMT-CI:height=“100%” MMT-CI:left=“0px” MMT-
CI:top=“0px”/>
  </div>
</body>
</html>
```

FIG. 13 illustrates an area information receiving procedure according to an embodiment of the present disclosure.

Referring to FIG. 13, the first one area information Area1 is displayed, but new area information received may be displayed complementarily. To this end, a mark-up may be composed to include information about an empty space that can be received, making it possible to prevent the entire scene configuration from being broken even after new area information is received.

The embodiment described in conjunction with FIG. 13 may be represented in code as in Table 10 below.

```
TABLE 10
<!DOCTYPE html>
<html xmlns=“http://www.w3.org/1999/xhtml”>
<head>
  <MMT-CI:view id=“View1” MMT-CI:viewtype=“default”>
    <MMT-CI:divLocation id=“divL1” style=“position:absolute;
width:100%; height:100%; left:0px; top:0px” MMT-CI:refDiv=“Area1”/>
  </MMT-CI:view>
  <MMT-CI:view id=“View2” MMT-CI:viewtype=“receptible” >
    <MMT-CI:divLocation id=“divL2” style=“position:absolute;
width:70%; height:100%; left:0%; top:0%” MMT-CI:refDiv=“Area1”/>
    <MMT-CI:divLocation id=“divL3” style=“position:absolute;
width:30%; height:100%; left:70%; top:0%” MMT-CI:plungeIn=“1”/>
  </MMT-CI:view>
</head>
<body>
  <div id=“Area1” style=“width:1000px; height:1000px”>
    <video id=“video1” src=“mmt://package1/asset1”/>
  </div>
</body>
</html>
```

Examples of providing scene configuration information as a separate file will not be separately described, for FIGS. 11, 12, and 13. These examples may be sufficiently described with reference to the method illustrated in Table 7.

FIG. 14 illustrates a structure of a server providing a multimedia service based on multiple screens according to an embodiment of the present disclosure. It should be noted that among the components constituting the server, it is the components needed for an embodiment of the present disclosure that are illustrated in FIG. 14.

Referring to FIG. 14, a mark-up generator 1410 (i.e. at least one processor of the server configured to perform the functionality described herewith) may generate at least one mark-up file for a multimedia service based on multiple screens. The mark-up file may have the structure illustrated in FIG. 5A or FIG. 5B.

For example, the mark-up generator 1410 may generate one mark-up file including scene layout information and scene configuration information, or generate one mark-up file including scene layout information and another mark-up file including scene configuration information.

The scene layout information may include scene layout information for one multimedia device, and scene layout information for multiple multimedia devices. The scene layout information for one multimedia device is for a main multimedia device. The scene layout information for multiple multimedia devices is for a main multimedia device (i.e., a primary device) and at least one sub multimedia device (i.e., a secondary device).

The scene layout information for one multimedia device may include a view type ‘default’ and location information. The view type ‘default’ is a value for indicating that the scene layout information is for one multimedia device. The location information is information used to place at least one scene for a multimedia service on a screen of the one multimedia device.

The scene layout information for multiple multimedia devices may include a view type ‘multiple’, location information, plunge-out information, and the like.

The view type ‘multiple’ is a value for indicating that the scene layout information is for multiple multimedia devices. The location information is information used to place at least one scene for a multimedia service on a screen, for each of the multiple multimedia devices. The plunge-out information defines a method for sharing the least one scene by the multiple multimedia devices. The plunge-out information may be included in location information for a sub multimedia device.

An example of the view type is defined in Table 3, and an example of the plunge-out information is defined in Table 4.

A transmitter 1420 may transmit at least one mark-up file generated by the mark-up generator 1410. The at least one mark-up file transmitted by the transmitter 1420 may be provided to a main multimedia device, or to the main multimedia device and at least one sub multimedia device.

The structures and operations of the main multimedia device and at least one sub multimedia device, all of which support a multimedia device by receiving at least one mark-up file transmitted by the transmitter 1420, have been described above.

As is apparent from the foregoing description, according to the present disclosure, as a connection relationship between multiple devices and information that may be processed by each device may be described with one mark-up file, a service provider may easily provide a consistent service without the need to manage the connection relationship between complex devices or the states thereof.

In addition, a second device that is not directly connected to the service provider may receive information about its desired part from a first device, and process and provide the received information, and even when there is a change in a state of a device existing in the network, the second device may detect the change, and change the scene's spatial configuration in real time by applying the scene layout information corresponding to the detected change.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for providing a multi-screen service by a first multimedia device in a network, the method comprising:
identifying composition information for the multi-screen service;
obtaining scene layout information for a view from the composition information;
identifying view type information of a view element included in the scene layout information;
if the view type information includes a first view type value indicating to generate an empty space for receiving a first area from a second multimedia device, generating the empty space on a primary screen of the first multimedia device based on the first view type value;
receiving the first area from the second multimedia device; and
presenting the first area in the empty space on the primary screen,
wherein the first area is a spatial region related to one or more media elements.

2. The method of claim 1, further comprising:
if the view type information includes a second view type value indicating that there is one multimedia device in the network, identifying first information corresponding to the second view type value in the scene layout information; and
configuring the view to be presented on the primary screen based on the first information.

3. The method of claim 1, further comprising:
if the view type information includes a third view type value indicating that there is a plurality of multimedia devices in the network, identifying second information corresponding to the third view type value in the scene layout information;
identifying plunge-out information included in the second information, the plunge-out information being related to a second area included in the view;
if the plunge-out information includes a first plunge-out value indicating that the second area is allowed to be shown at only a secondary screen of a second multimedia device among the plurality of multimedia devices, transmitting, to the second multimedia device, information for presenting the second area on the secondary screen only; and
if the plunge-out information includes a second plunge-out value indicating that the second area is allowed to be shown at both the primary screen and the secondary screen, transmitting, to the second multimedia device, information for presenting the second area on the secondary screen, and presenting the second area on the primary screen.

4. The method of claim 3, wherein the second area is invisible at the primary screen if the plunge-out information includes the first plunge-out value.

5. The method of claim 1, wherein the one or more media elements include one or more of a video, an audio, an image, or a text.

6. A first multimedia device for providing a multi-screen service in a network, the first multimedia device comprising:
a transceiver;
a display; and
at least one processor configured to:
identify composition information for the multi-screen service,
obtain scene layout information for a view from the composition information,
identify view type information of a view element included in the scene layout information,
if the view type information includes a first view type value indicating to generate an empty space for receiving a first area from a second multimedia device, control the display to generate the empty space on a primary screen of the first multimedia device based on the first view type value,
control the transceiver to receive the first area from the second multimedia device, and
control the display to present the first area in the empty space on the primary screen,
wherein the first area is a spatial region related to one or more media elements.

7. The first multimedia device of claim 6, wherein the at least one processor is further configured to:
if the view type information includes a second view type value indicating that there is one multimedia device in the network, identify first information corresponding to the second view type value in the scene layout information, and
configure the view to be presented on the primary screen based on the first information.

8. The first multimedia device of claim 6, wherein the at least one processor is further configured to:
if the view type information includes a third view type value indicating that there is a plurality of multimedia devices in the network, identify second information corresponding to the third view type value in the scene layout information,
identify plunge-out information included in the second information, the plunge-out information being related to a second area included in the view,
if the plunge-out information includes a first plunge-out value indicating that the second area is allowed to be shown at only a secondary screen of a second multimedia device among the plurality of multimedia devices, control the transceiver to transmit, to the second multimedia device, information for presenting the second area on the secondary screen only, and
if the plunge-out information includes a second plunge-out value indicating that the second area is allowed to be shown at both the primary screen and the secondary screen, control the transceiver to transmit, to the second multimedia device, information for presenting the second area on the secondary screen, and control the display to present the second area on the primary screen.

9. The first multimedia device of claim 8, wherein the second area is invisible at the primary screen if the plunge-out information includes the first plunge-out value.

10. The first multimedia device of claim 6, wherein the one or more media elements include one or more of a video, an audio, an image, or a text.
